(19) United States
(12) Patent Application Publication
(10) Pub. No.: US 2008/0148524 A1
(43) Pub. Date: Jun. 26, 2008

(54) HANDLE

(76) Inventors: Juergen Wiker, Hangzhou (CN); Bernhard Eicher, Filderstadt (DE); Joachim Schadow, Dettenhausen (DE); Stefan Heess, Leinfelden-Echterdingen (DE); Mario Frank, Hangzhou (CN); Siegfried Keusch, Deizisau (DE); Ulrich Mueller-Boysen, Esslingen (DE); Joerg Maute, Sindelfingen (DE); Florian Esenwein, Uhingen-Holzhausen (DE); Marcus Schuller, Dettenhausen (DE); Roswitha Eicher, Filderstadt (DE)

Correspondence Address: Striker, Striker & Stenby, 103 East Neck Road, Huntington, NY, 11743, US

(21) Appl. No.: 11/946,393

(22) Filed: Nov. 28, 2007

(30) Foreign Application Priority Data
Dec. 22, 2006 (DE) 102006061247.7

(51) Int. Cl. B25F 5/02

(52) U.S. Cl. 16/431

(57) ABSTRACT

A handle includes a handle sleeve and a handle core, the handle core includes a fastening element on one end and extends to the end of the handle sleeve opposite to the fastening element, an intermediate space is located between the handle sleeve and the handle core, and at least one dampening element is provided in the intermediate space, and the handle core includes a contactless overhanging section in the handle sleeve.

### CROSS-REFERENCE TO A RELATED APPLICATION

The invention described and claimed hereinbelow is also described in German Patent Application DE 102006061247.7 filed on Dec. 22, 2006. This German Patent Application, whose subject matter is incorporated here by reference, provides the basis for a claim of priority of invention under 35 U.S.C. 119(a)-(d).

### BACKGROUND OF THE INVENTION

The present invention relates to a handle, in particular for a hand-held power tool.

Numerous power tools, such as angle grinders, drills, and rotary hammers, are equipped with an extra handle. To prevent vibrations that occur during operation of the power tool from being transmitted to the operator via the additional handle, additional handles are often provided with vibration-dampening means.

Publication DE 103 48 973 Al makes known a vibration-dampened handle that includes a sleeve-shaped outer handle element and a sleeve-shaped or cylindrical inner handle core. The inner handle core is designed concentric with the outer handle element and distanced therefrom. The handle core and the handle element therefore enclose an intermediate space with the shape of a hollow cylinder. The handle core includes a fastening section on its device-side end, which extends out of the handle element. Vibration-dampening means in the form of spacers made of a resilient, preferably elastomeric material are provided in the intermediate space between the handle element and the handle core. The spacers made of resilient material are, e.g., rings, ribs, or nubs.

The handle made known in DE 103 48 973 A1 has the disadvantage that it is not secured against being pulled off. If the resilient material of the spacer tears, e.g., due to material fatigue, there is a risk that the handle element and the handle core will become separated. In this case, only the handle core would be retained on the hand-held power tool, and the handle element would become separated from the hand-held power tool.

### SUMMARY OF THE INVENTION

Accordingly, it is an object of the present invention to provide a handle, in particular for a hand-held power tool which is a further improvement of the existing handles.

The present invention is directed to a handle with a handle shell and a handle core. At one end, the handle core is equipped with a fastening element for attaching the handle to the hand-held power tool, the handle core extending to the end of the handle sleeve opposite to the fastening element. An intermediate space is located between the handle sleeve and the handle core. The handle sleeve and handle core therefore do not contact each other. The handle sleeve is essentially designed, e.g., as a hollow cylinder. The handle core is essentially shaped, e.g., as a cylinder, and is coaxial with the handle sleeve. At least one dampening element is provided in the intermediate space between the handle sleeve and the handle core. The dampening element reduces the transmission of vibrations from the handle core to the handle sleeve and, therefore, to the operator of the hand-held power tool.

To safeguard the handle from being pulled off, the handle core and the handle sleeve are designed such that the handle core has a contactless overhanging section in the handle sleeve. The overhanging section is designed to be contactless, since the handle core and the handle sleeve do not touch each other, but rather are connected with each other only via dampening elements. The handle core comes in contact with the handle sleeve only when the dampening element fails. The overhanging section prevents the handle core and handle sleeve from becoming separated. The contactless overhanging section therefore ensures axial retention if the dampening element should fail.

In particular, the handle core includes the contactless overhanging section in the region of the end of the handle sleeve opposite to the fastening element. The handle core is therefore preferably provided with at least one overhanging section in the region of the end opposite to the fastening element.

A base, as the overhanging section, is preferably formed on the end of the handle core opposite to the fastening element. A “base” is considered to be a widening of the handle core on the end opposite to the fastening element.

In one embodiment, the base is formed by a screw head. To this end, a screw is screwed into the handle core on the end of the handle core opposite to the fastening element, the screw head of which extends beyond the handle core in the radial direction. The diameter of the screw head is greater than the inner diameter of the handle sleeve, so that, if the dampening element should fail, the screw head comes to bear against the inner wall of the handle sleeve.

As an alternative, the base may also be formed by a disk that is integrally moulded or fastened, e.g., screwed together, with the free end of the handle core.

In another embodiment, the fastening element is designed as a single piece with the handle core. The handle core with the fastening element is a screw, the screw neck of which is located—coaxially therewith, in particular—in the handle sleeve, and the screw head of which forms a contactless overhanging section on the free end of the handle sleeve. At least one portion of the thread of the screw extends—as the fastening element—out of the handle sleeve.

In addition or as an alternative to one or more overhanging elements on the handle core, at least one overhanging element may be formed on the handle sleeve. The overhanging elements extend into the interior of the handle sleeve and/or into the intermediate space between the handle sleeve and the handle core. Locking pawls, for example, as the overhanging elements, are integrally formed on the inner wall of the handle sleeve.

The inventive handle is preferably designed in the shape of a rod or stem or the like. The handle sleeve of the handle is essentially hollow-cylindrical in shape. In a simple embodiment, this may be a hollow cylinder. In a more advanced embodiment, the hollow-cylindrical handle sleeve may also be adapted to the ergonomy of the human hand by providing it, e.g., with different diameters along its longitudinal axis, in deviation from a purely hollow cylindrical shape. The handle sleeve may be designed with rotational symmetry, so that the handle may be gripped by the operator in any orientation, or it may be adapted to the ergonomy of the hand such that a contact surface is formed for the surface of the hand and contact surfaces are formed for the fingers.

The handle sleeve may be made of plastic, e.g., polyamide. It may also be coated with a soft component, e.g., an elastic material, e.g., an elastomer.

The handle core is preferably designed in the shape of a cylindrical rod, stem, or the like, which is coaxial, in particular, with the handle core. The handle core may also be designed as a hollow cylinder, in which, e.g., additional vibration-dampening means such as an absorber mass may be accommodated.

In a simple embodiment, the handle core and the fastening element may be designed as a single piece. To this end, the handle core is formed by a screw, the screw neck of which is coaxial with and distanced from the handle sleeve. The screw head forms a contactless overhanging section in the handle sleeve on the free end of the handle. At least one portion of the thread extends out of the handle sleeve on the opposite end. The thread of the screw is the fastening element.

The fastening element may also be designed in another manner, as a separate piece. In a simple embodiment, it may be, e.g., a threaded bolt or a screw that is installed in the handle core. The screw head is accommodated in the handle core, and the free end of the screw, with the thread, extends out of the handle core and the handle sleeve.

Instead of a threaded bolt, a screw, or the like, a clamping device, for example, for connecting the handle with the housing of a hand-held power tool may be provided as the fastening element.

In a further alternative embodiment, the fastening element may be designed as a receiving sleeve with a nut. The receiving sleeve serves to receive a screw, which is connectable with the nut. A screw may be installed on the housing of the hand-held power tool. To attach the handle to the hand-held power tool, the screw is inserted in the receiving sleeve and is screwed together with the nut. The screw may be installed on the housing, e.g., using a clamping device.

The dampening element may be made, e.g., of an elastic material, of an elastomer in particular. The intermediate space between the handle core and the handle sleeve may be filled entirely with the dampening element, e.g., by injecting a thermoplastic elastomer into the intermediate space between the handle core and the handle sleeve. Several individual dampening elements in the form of nubs, rings, or ribs made of an elastomeric material may also be provided between the handle core and the handle sleeve. Likewise, other vibration-dampening materials, such as foams or gels and other liquid cushions may be used as dampening elements. Spring elements such as leaf springs, helical springs, etc., may also be used as dampening elements.

The handle is suited, in particular, for use as an additional handle for a hand-held power tool, e.g., for an angle grinder, a rotary hammer, or a drill.

A further object of the present invention is a hand-held power tool that includes at least one inventive handle.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a first embodiment of an inventive handle

FIG. 2 shows a second embodiment of an inventive handle

FIG. 3 shows a third embodiment of an inventive handle

FIG. 4 shows a fourth embodiment of an inventive handle

FIG. 5 shows a fifth embodiment of an inventive handle.

### DESCRIPTION OF THE PREFERRED EMBODIMENTS

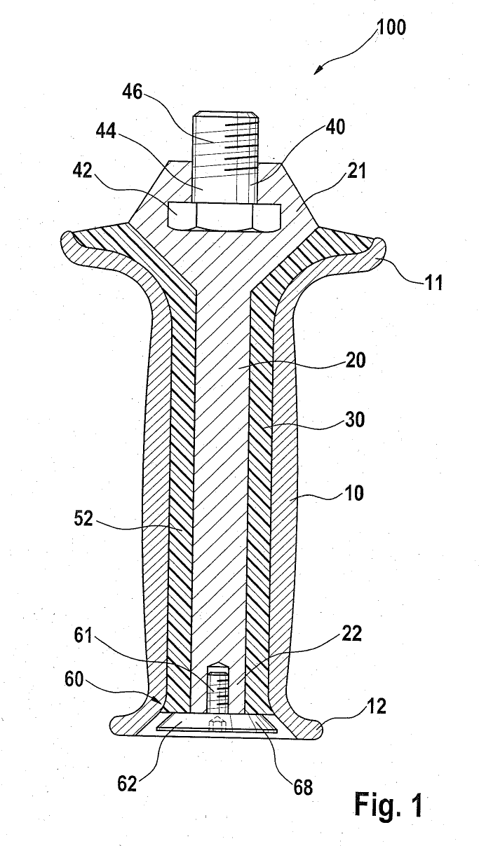

FIG. 1 shows a first embodiment of an inventive handle 100, which may be used as an additional handle for a mains-operated or cordless hand-held power tool (not shown). Handle 100 includes a handle sleeve 10, which is designed essentially as a hollow cylinder. A handle core 20 is coaxial with and distanced from handle sleeve 10. Handle core 20 is designed essentially as a cylinder. Handle core 20 accommodates a fastening element 40 on its upper end shown in FIG. 1. In the embodiment shown, fastening element 40 is a screw, screw head 42 of which is accommodated in handle core 20, and screw neck 44—with screw thread 46—of which extends at least partially out of handle core 20 and handle sleeve 10.

Fastening element 40 serves to detachably attach handle 100 to a not-shown hand-held power tool. Handle core 20 extends essentially from one end 11 of handle sleeve 10 to the other end 12. Handle core 20 may also extend out of handle sleeve 10 at its end 21 facing fastening element 40, as shown in FIGS. 1, 2, and 5. End 22 of handle core 20 facing away from fastening element 40 extends essentially to end 12 of handle sleeve 10.

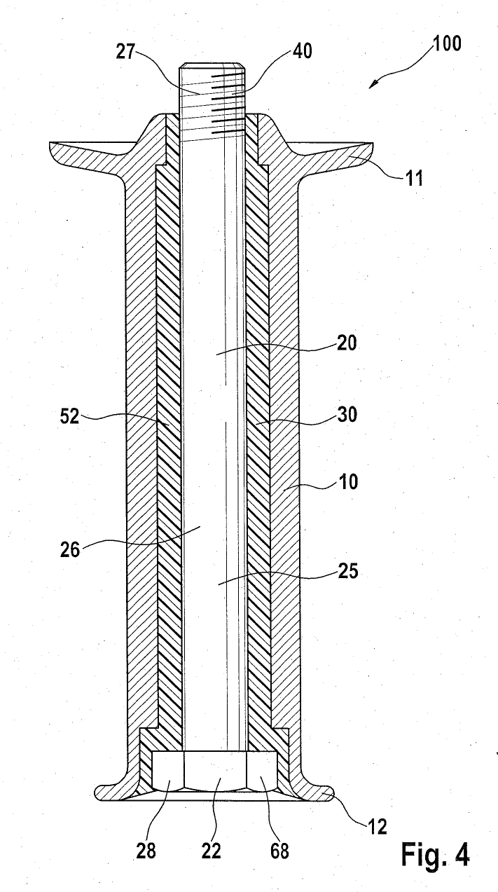

An intermediate space 30 is located between handle core 20 and handle sleeve 10. Handle core 20 and handle sleeve 10 therefore do not contact each other. A dampening element 52 is accommodated in intermediate space 30, with which vibrations that occur on handle 100 during operation of the hand-held power tool are reduced. In the embodiments shown in FIGS. 1 and 4, dampening element 52 essentially fills entire intermediate space 30. For this purpose, an elastic material, e.g., an elastomer or a foam, may be inserted, e.g., injected, into intermediate space 30.

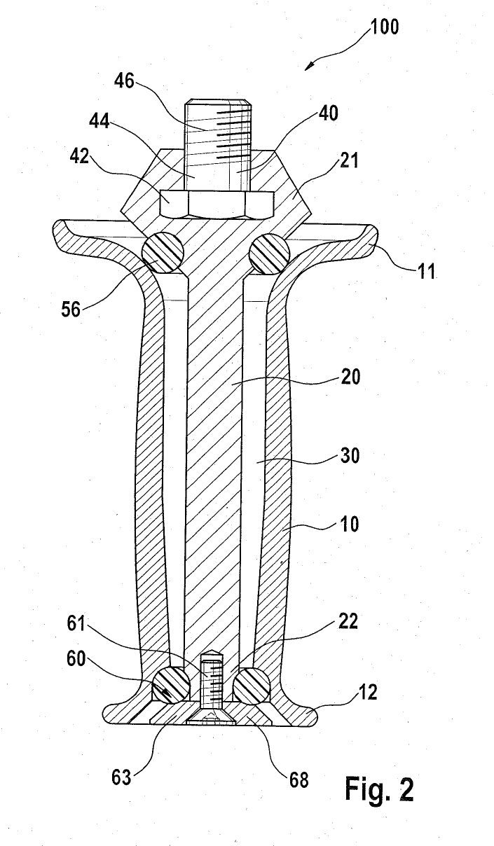

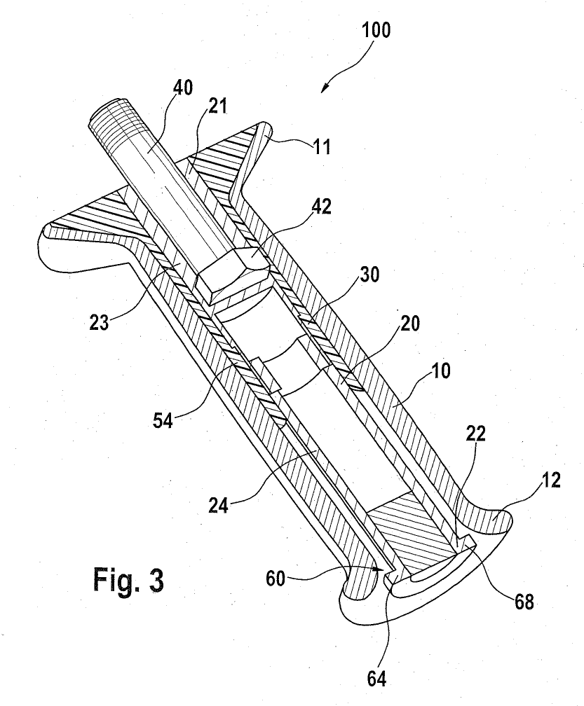

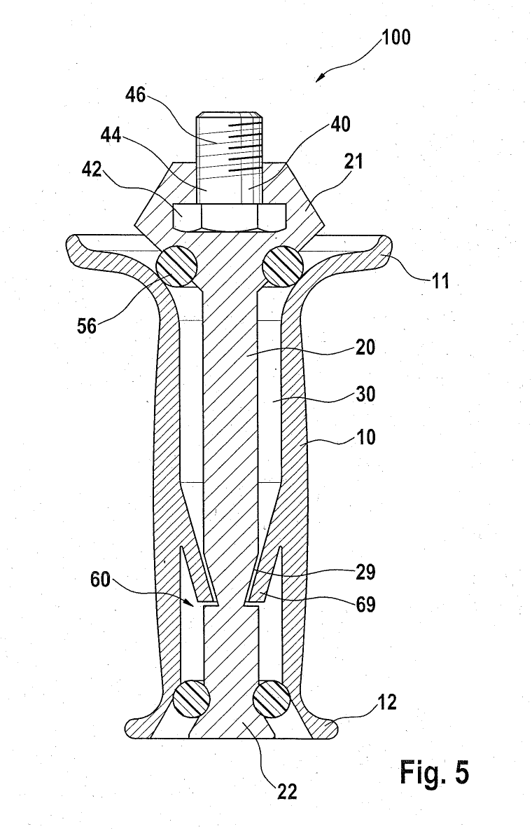

As an alternative, in the embodiment shown in FIG. 3, dampening element 54 may fill intermediate space 30 only partially. In a further embodiment, as shown in FIGS. 2 and 5, several individual dampening elements 56 in the form of rings made of an elastic material, e.g., an elastomeric material, are placed in intermediate space 30. Further types of dampening elements, such as liquid or gas cushions, spring elements, etc., are also possible.

According to the present invention, handle core 20 and handle sleeve 10 are designed and positioned relative to each other such that handle core 20 forms a contactless overhanging section 60 in handle sleeve 10. Overhanging section 60 is referred to as “contactless” because handle core 20 and handle sleeve 10 are separated by intermediate space 30, and they do not contact each other.

Contactless overhanging section 60 therefore does not impair the vibration-dampening property of dampening element 52. Overhanging section 60 does prevent handle sleeve 10 from becoming separated from handle core 20 if dampening element 52 eventually fails, due, e.g., to damage or material fatigue. If dampening element 52 fails, handle core 20 comes to bear against handle sleeve 10 due to overhanging section 60.

To form a contactless overhanging section 60 of this type, in the exemplary embodiments according to FIGS. 1 through 4, an overhanging section element 68 in the form of a base is formed on handle core 20, on its end 22 facing away from fastening element 40. The base increases the cross section of handle core 20 such that the cross section is greater than the inner cross section of handle sleeve 10, at least in one region of handle sleeve 10. In a first embodiment, as shown in FIG. 1, the base is formed by a screw head 62. To this end, a screw 61 is installed on the end face of handle core 20 opposite to fastening element 40 such that screw head 62 extends radially beyond handle core 20.

In a second embodiment, as shown in FIG. 2, the base is formed by a disk 63, which is installed, as a separate piece, on the end face of handle core 20 using a screw 61. Similar to screw head 62 shown in FIG. 1, disk 63 extends beyond handle core 20 in the radial direction. In a further embodiment, as shown in FIG. 3, the base is integrally formed directly on handle core 20, in the form of a collar 64.

In the embodiment shown in FIG. 4, handle core 20 is designed as a single piece with fastening element 40. A screw 25 is installed in handle sleeve 10 such that it performs the function of handle core 20 and fastening element 40. Screw neck 26 is coaxial with handle sleeve 20 and serves as handle core 20. Screw thread 27 extends at least partially out of handle sleeve 20 and serves as fastening element 40. Screw head 28 is located on opposite end 12 of handle sleeve 10, and performs the function of overhanging element 68.

In the embodiment shown in FIG. 3, in contrast to the other embodiments, handle core 20 is designed at least partially as a hollow cylinder. This makes it possible to provide further dampening means inside handle core 20. In FIG. 3, for example, an absorber mass 29 is also provided in handle core 20. Absorber mass 29 may be fixed in position, or it may be supported via spring action. It may also be designed to be replaceable, so that, depending on the application, an absorber mass having a larger or smaller mass may be inserted.

The axial position of absorber mass 29 inside handle core 20 may also be designed to be variable, e.g., using a thread (not shown). A further difference between handle core 20 shown in FIG. 3 is that handle core 20 has a two-pieced design. A first piece 23 of handle core 20 serves to accommodate fastening element 40 on one end, and a second piece 24 on the other end. Second piece 24 may be designed such that it is displaceable in the axial direction, e.g., using a thread (not shown). This allows the operator of the hand-held power tool to adjust the vibration-dampening properties and to therefore adapt to the particular application.

In a further embodiment of inventive handle 100, as shown in FIG. 5, overhanging elements 64 in the form of locking pawls are provided on handle sleeve 10. These overhanging elements 69 are also designed such that a contactless overhanging section 60 is formed that prevents handle sleeve 10 from becoming separated from handle core 20 if dampening element 56 should fail. The locking pawls are integrally formed on handle sleeve 10 such that they extend into the interior of handle 100. Recesses 29 are provided in handle core 20 for this purpose, in which the locking pawls engage in a contactless manner.

The various forms of overhanging elements 68, 69 may also be used in combination.

It will be understood that each of the elements described above, or two or more together, may also find a useful application in other types of constructions differing from the type described above.

While the invention has been illustrated and described as embodied in a handle, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A handle, comprising a handle sleeve; a handle core, said handle core including a fastening element on one end and extending to an end of said handle sleeve opposite to said fastening element, wherein said handle sleeve and said handle core include an intermediate space therebetween; at least one dampening element provided in said intermediate space, said handle core including a contactless overhanging section in said handle sleeve.

2. A handle as defined in claim 1, wherein said handle core includes said contactless overhanging section in a region of said end of said handle sleeve opposite to said fastening element.

3. A handle as defined in claim 1, wherein said handle core is provided with at least one overhanging section element in a region of an end opposite to said fastening element.

4. A handle as defined in claim 3, wherein a base is formed as said overhanging section element in the region of said end of said handle core opposite to said fastening element.

5. A handle as defined in claim 4, wherein said base which is formed as said overhanging element is configured as a screw head.

6. A handle as defined in claim 4, wherein said base which is formed as said overhanging element is configured as a disk.

7. A handle as defined in claim 4, wherein said base is configured as a collar which is integrally moulded with said handle core.

8. A handle as defined in claim 1, wherein said fastening element is configured as a single piece with said handle core.

9. A handle as defined in claim 8, wherein said handle core and said fastening element configured therewith integrally as a single piece is a screw with a screwhead forming an overhanging element.

10. A handle as defined in claim 1; and further comprising at least one overhanging element formed on said handle sleeve.

11. A handle as defined in claim 10, wherein locking pawls formed as said at least one overhanging element, are integrally moulded with said handle sleeve.

12. A hand-held power tool, comprising a handle, said handle including a handle sleeve and a handle core, said handle core including a fastening element on one end and extending to an end of said handle sleeve opposite to said fastening element, wherein said handle sleeve and said handle core include an intermediate space therebetween, at least one dampening element is provided in said intermediate space, and said handle core includes a contactless overhanging section in said handle sleeve.
